(19) United States
(12) Patent Application Publication
(10) Pub. No.: US 2026/0291411 A1
(43) Pub. Date: Sep. 24, 2026

(54) METHOD FOR DETERMINING THE ROTOR POSITION OF AN EC MOTOR

(71) Applicant: Schaeffler Technologies AG & Co. KG, Herzogenaurach (DE)

(72) Inventors: Christian Brunner, Rheinstetten (DE); Alexander Rösch, Herzogenaurach (DE)

(73) Assignee: Schaeffler Technologies AG & Co. KG, Herzogenaurach (DE)

(21) Appl. No.: 19/473,590

(22) PCT Filed: Feb. 9, 2024
(86) PCT No.: PCT/DE2024/100115

§ 371 Date: Oct. 8, 2025

(30) Foreign Application Priority Data
Apr. 11, 2023 (DE) 10 2023 109 006.2

(51) Int. Cl. H02P 6/18; H02P 21/00; H02P 21/18

(52) U.S. Cl. CPC H02P 6/183; H02P 21/0003; H02P 21/18; H02P 2203/11

(57) ABSTRACT

For an EC motor, the position of the rotor thereof is determined by injecting a voltage signal and evaluating the resulting current fluctuations in the phases of the EC motor. The injection is suspended for each phase respectively when the voltage in the phase is close to a maximum value.

### CROSS-REFERENCE TO RELATED APPLICATIONS

This application is the United States National Phase of PCT Appln. No. PCT/DE2024/100115 filed Feb. 9, 2024, which claims priority to German Application No. DE 102023109006.2 filed Apr. 11, 2023, the entire disclosures of which are incorporated by reference herein.

### FIELD OF INVENTION

The invention relates to a method for determining the rotor position of an electronically commutated electric motor (EC motor) based on injection.

### BACKGROUND

To control an EC motor, it is necessary to know the position of the rotor of the EC motor. The position of the rotor can be determined in different ways using various sensors. One possibility is to feed voltage signals into the phases of the stator of the EC motor in addition to the voltages required to drive the EC motor, also referred to as injecting the voltage signals, and to measure the resulting currents in the phases. The position of the rotor can be calculated from the current fluctuations generated by the injected voltage signals. This procedure is well known per se.

However, it is also known that the maximum available voltage for operating an EC motor is limited to one phase of the stator of the EC motor, generally via an intermediate circuit voltage. This means that if the voltage in a phase is sufficiently close to its maximum value, the injection of voltage signals into this phase and the subsequent evaluation of the resulting current fluctuations can no longer function reliably, since the injected voltage signals would exceed the maximum available voltage. EP 2 144 362 B1 therefore proposes to supplement the injection of voltage signals and evaluation of current fluctuations at higher speeds with an estimate based on machine parameters. This requires the use of additional sensors (e.g., for temperature) to determine the machine parameters. An acceleration sensor is used to check the plausibility of the speed signal and is weighted differently for this purpose.

US 2017/0 264 227 A1 describes a method for determining a rotor position of a multi-phase EC motor comprising injecting a voltage signal into at least two phases of the stator, detecting a respective current signal in each of the phases and determining the rotor position from the detected current signals.

U.S. Pat. No. 11,264,930 B2 also describes injecting a voltage signal into a phase.

When controlling an EC motor, the voltage or current values of the phases of the stator can be transformed in a known manner to a two-dimensional coordinate system, the mutually perpendicular axes of which are usually referred to as d (“direct”) and q (“quadrature”). This coordinate system rotates relative to the stator of the EC motor and rests relative to the rotor of the EC motor. The transformation itself is called the Park transformation; the two-dimensional coordinate system to which it is transformed is called the Park coordinate system. The Park transformation can occur via the intermediate step of an, also known, Clarke transformation, which transforms the voltage values or current values of the phases of the stator to a two-dimensional, orthogonal coordinate system that is stationary relative to the stator. The q and d components of the voltage can be controlled via separate controllers.

### SUMMARY

It is an object of the present disclosure to provide an injection method for determining the position of the rotor of an EC motor that addresses the limitations of the prior art.

This object is achieved by a method according to claim 1. The dependent claims relate to advantageous embodiments.

The method according to the present disclosure for determining a position of a rotor of a multi-phase EC motor includes at least the following steps.

A voltage signal is injected into at least two phases of the stator of the EC motor. This voltage signal is an additional voltage to the voltage applied to the respective phase for the purpose of driving the EC motor. The respective voltage signal injected into a phase results in a current signal in that phase that is superimposed on the current flowing for drive purposes. This current signal is detected in each of the at least two phases into which a voltage signal has been injected, so that a respective current signal is present for each of the at least two phases. The position of the rotor is determined in a known manner from the current signals detected in this way. According to the present disclosure, the injection of the voltage signal into a phase of the stator of the EC motor is suspended when the voltage at this phase falls below a predefined distance from a maximum voltage for this phase. The predefined distance is chosen to be at least great enough so that even when the voltage signal is injected into the respective phase, the maximum voltage for this phase is not exceeded. It should be noted that the voltage signal to be injected is known in advance. Since voltage signals are usually injected into at least two phases of the stator of the EC motor, if the injection into one of the phases is stopped, at least one phase still remains from which current signals can be detected to determine the position of the rotor of the EC motor. This applies regardless of the speed of the rotor. At relatively low speeds, the maximum voltage at the phases is always significantly undershot, so that the injection of the voltage signal and the detection of the resulting current signal are possible without any issues. In the method according to the present disclosure, however, the rotor can also rotate at a comparatively high speed and the voltages at the phases of the stator of the EC motor can reach the maximum voltage. Nevertheless, the position of the rotor can be determined using the method according to the present disclosure. No additional sensors, such as temperature or acceleration sensors, are required as in the prior art. The EC motor can still be operated up to the maximum voltage on the phases, which means an upwardly extended performance range of the EC motor.

In one embodiment, the stator of the EC motor has three phases. The position of the rotor is determined based on current signals from the phases in which the injection of the voltage signal is not interrupted. At any given time during operation, these are either two or three phases; since the voltages on the phases are offset by 120° from each other, the control can be designed in such a way that the injection of the voltage signal is never interrupted in two or even all three phases at the same time. For this purpose, the predefined distance must be selected appropriately, in particular the predefined distance must not be selected to be too great. The predefined distance must be selected so that at any time during operation of the EC motor a voltage is applied to at most one of the phases which falls below the predefined distance from the maximum voltage. At the same time, the predefined distance must be selected so that when the voltage signal is injected into a phase, the resulting voltage on the phase does not exceed the maximum voltage. What is important here is the maximum values of the voltage signal, but these can be selected to be small in relation to the amplitudes of the voltage applied to the phase for drive purposes, for example less than 5% of the amplitude of the voltage for drive purposes.

In a general embodiment, the EC motor is controlled by regulating the d and q components of the voltage from a Park transformation of the voltages on the phases. The injection of the voltage signal occurs exclusively into the d component, since the voltage signal does not cause any torque fluctuations of the EC motor. To suspend the injection of the voltage signal into a specific phase, the d component is set to a value calculated from the Park transformation.

The criterion for suspending the injection of the voltage signal into a particular phase can be checked by evaluating the voltage to be provided by a controller used for control. If the voltage to be set on the phase comes closer to the maximum voltage for the phase than the predefined distance, the injection of the voltage signal is suspended. However, it is also possible to derive the condition for suspending injection from the determined position of the rotor. This means that the voltage at each of the phases can be determined from the position of the rotor, which is determined using the method according to the present disclosure. Other options for checking the criterion for suspending injection are also conceivable.

The present disclosure and the advantages thereof are explained in more detail below with reference to the accompanying schematic drawings.

### BRIEF DESCRIPTION OF THE DRAWINGS

FIG. 1 shows a diagram of an example embodiment of the method according to the present disclosure.

FIG. 2 shows the voltage on a phase without an injected voltage signal.

FIG. 3 shows the voltage on a phase without an injected voltage signal superimposed with the voltage including the voltage signal.

FIG. 4 corresponds to FIG. 3 with additional inclusion of the suspension of injection according to the present disclosure.

FIG. 5 shows an enlarged section from FIG. 4.

The figures merely refer to example embodiments of the present disclosure and are not to be construed as limiting the present disclosure to the example embodiments shown.

### DETAILED DESCRIPTION

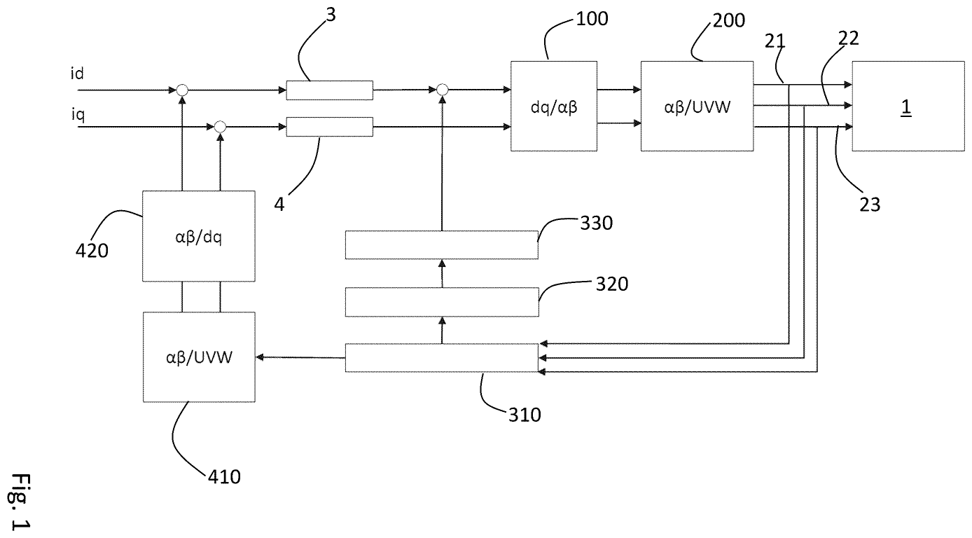

FIG. 1 shows a diagram of an example embodiment of the method according to the present disclosure. An EC motor 1 is supplied with voltage via three phases 21, 22, 23. The EC motor 1 is controlled via the q and d components (Id, Iq) of the currents in and/or voltages at the phases; these components can be controlled via the controllers 3 and 4, respectively. The controllers 3 and 4 can, for example, be proportional-integral controllers. Block 100 symbolizes the conversion of the controlled d/q components into the α/β components (Clarke coordinates). The latter components are converted (illustrated by block 200) into the UVW coordinates, which represent the voltage values of the individual phases and are accordingly fed to the EC motor 1 via the phases 21, 22, 23. At the same time, the currents are measured at the phases 21, 22, 23 and fed to a position determination (block 310). Here, the rotor position of the EC motor 1 is determined based on fluctuations in the current strengths resulting from voltage signals injected into the phases. Such an injected voltage signal is represented by block 320; subjected to a suspension condition 330, it is superimposed on the controlled d component and reaches the phases 21, 22, 23 of the EC motor 1 via transformations 100 and 200. The suspension condition 330 ensures that no voltage signal 320 is injected into a phase if this would result in the maximum voltage for that phase being exceeded. The suspension condition 330 can be checked via the voltages to be set with the controllers 3 and 4, such that the injection of the voltage signal 320 for a respective phase is omitted if the voltage to be set at this phase is closer to the maximum voltage than a predefined distance. Alternatively, the approach of the voltage at a phase to the maximum voltage can be determined from the rotor position, which is available through the position determination 310. Other approaches are also conceivable.

The feedback 410 and 420 provide the required d/q components based on the determined rotor position in order to correctly control the EC motor 1.

FIG. 2 shows the curve of the voltage U (in volts) at a phase of the stator of the EC motor 1 (see FIG. 1) as a function of time (in seconds), without an injected voltage signal. Over time, the voltage values of the local maxima 510 of the voltage curve increase and the duration period of the voltage curve decreases. In the situation shown, the rotation speed of the rotor of the EC motor increases. The voltage shown here is the voltage applied to the phase for the purpose of driving the EC motor.

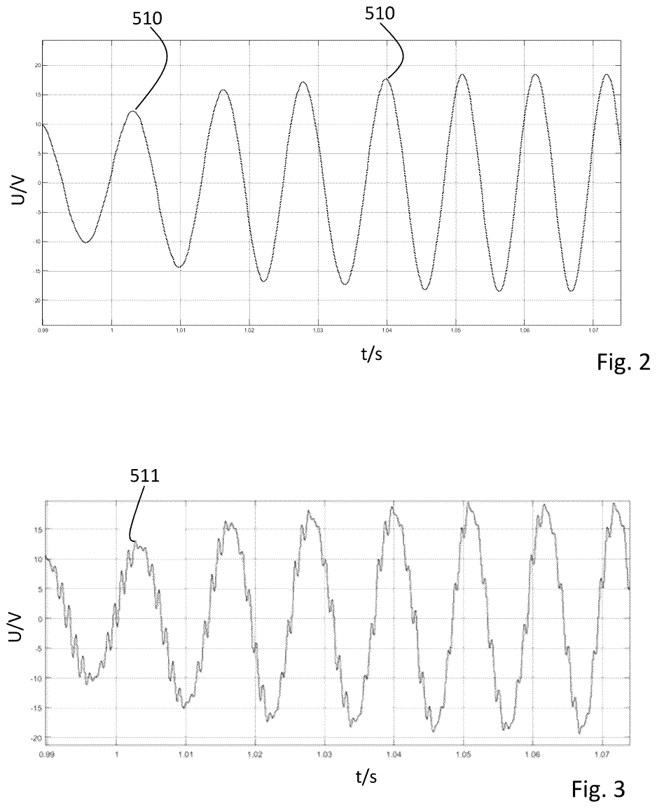

FIG. 3 shows again the course of the voltage U from FIG. 2 (dashed line); superimposed on this (as a solid line) is the course of the voltage U at the same phase of the stator of the EC motor with the injected voltage signal. It can be seen, for example in the area of the peak 511, that the voltage, including the injected voltage signal, exceeds the local maxima of the voltage already shown in FIG. 2. As long as the maximum voltage for the phase is not exceeded, this is not a problem. However, with increasing values of the local maxima 510 (see FIG. 2), i.e., with increasing rotation speed of the rotor of the EC motor, this can become problematic.

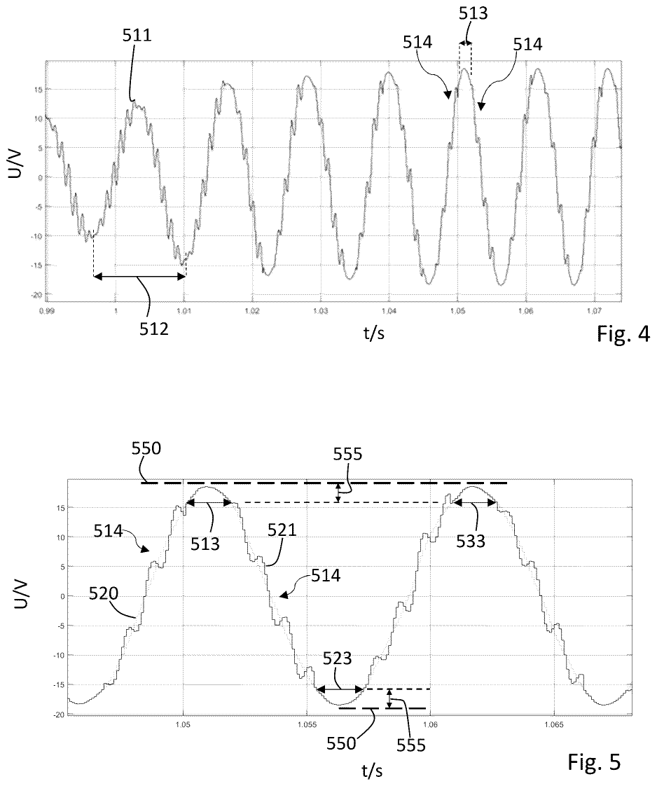

FIG. 4 shows the effects of the method according to the present disclosure on the voltage curve. As in FIG. 3, the voltage curve without injected voltage signal is shown (dashed), which also corresponds to the voltage curve in FIG. 2. The voltage including the injected voltage signal is shown superimposed on this voltage curve (as a solid line), but its injection is partially suspended in according to the present disclosure.

In the area of the peak 511, the voltage is still significantly below the maximum voltage for the phase, the injection is not interrupted, and the current signal in the phase caused by the injected voltage signal can be used during the entire duration 512 to determine the position of the rotor of the EC motor. As the height of the local maxima of the voltage increases, the suspension according to the present disclosure of the injection of the voltage signal comes into effect. For example, no voltage signal is injected into the phase during the time interval 513. This prevents the voltage signal from exceeding the maximum voltage for the phase. During the time interval 513, a current signal from this phase cannot be used to determine the position of the rotor. Outside the region 513, along the edges 514 of the voltage curve, the injection of the voltage signal into this phase takes place and the resulting current signal from this phase can be used along the edges 514 to determine the position of the rotor.

FIG. 5 is an enlarged section from FIG. 4. It shows the voltage curve 520 without injected voltage signal, which corresponds to the curve shown in FIG. 2. The voltage curve 521 including the superimposed voltage signal is superimposed on the voltage curve 520. During the time intervals 513, 523 and 533, the injection of the voltage signal into the phase to which the illustrated voltage curves 520, 521 refer is suspended. Here, the voltage curve 521 is at values that are closer to the maximum voltage 550 than a predefined distance 555. However, during the time intervals 513, 523, 533, the voltage curves of the further phases of the EC motor are sufficiently far away from the maximum voltage 550, such that an injection of the voltage signal for the further phases is possible during the time intervals 513, 523, 533. Therefore, the resulting current signals from these further phases during the time intervals 513, 523, 533 can be used to determine the rotor position. If the voltage at one of the further phases approaches the maximum value 550, such that the injection of the voltage signal into this further phase is suspended, the voltage curve 521 for the phase to which FIG. 5 refers is sufficiently far away from the maximum value 550 of the voltage, for example in one of the edges 514, so that current signals from the phase to which FIG. 5 refers are available to determine the position of the rotor of the EC motor.

### LIST OF REFERENCE SIGNS

1 EC motor
3 Controller
4 Controller
21 Phase
22 Phase
23 Phase
100 Coordinate conversion
200 Coordinate conversion
310 Position determination
320 Injected voltage signal
330 Suspension condition
410 Feedback
420 Feedback
510 Local maximum
511 Peak
512 Duration
513 Time interval
514 Edge
520 Voltage curve
521 Voltage curve
523 Time interval
533 Time interval
550 Maximum value (voltage)
555 Predefined distance

1. A method for determining a position of a rotor of a multi-phase electronically commutated (EC) motor, comprising:
injecting a voltage signal into at least two phases of a stator of the EC motor;
detecting a respective current signal in each of the at least two phases of the stator of the EC motor;
determining the position of the rotor from the detected current signals;
wherein
the injection of the voltage signal into a first phase of the at least two phases is suspended when a voltage at the first phase falls below a predefined distance from a maximum voltage for the first phase.

2. The method according to claim 1, wherein thea stator of the EC motor has three phases and the position of the rotor is determined from current signals of the respective phases in which the injection of the voltage signal is not suspended.

3. The method according to claim 2, wherein the EC motor is controlled by regulating direct (d) and quadrature (q) components of a voltage from a Park transformation of voltages of the phases, and wherein the voltage signal is injected exclusively into the d component.

4. The method according to claim 1, wherein a condition for suspending the injection is derived from the determined position of the rotor.

5. The method according to claim 1, further comprising controlling the EC motor based upon the determined rotor position.

6. A method for determining rotor position for a multi-phase electronically commutated (EC) motor:
injecting a voltage signal into at least two phases of a stator of the EC motor;
detecting a current signal in each of the at least two phases of the stator of the EC motor; and
determining a position of the rotor based at least in part upon the detected current signals;
wherein the injection of the voltage signal into a first phase of the at least two phases is suspended when a voltage at the first phase falls below a predefined distance from a maximum voltage for the first phase.

7. The method according to claim 6, wherein a stator of the EC motor has three phases and the position of the rotor is determined from current signals of the phases in which the injection of the voltage signal is not suspended.

8. The method according to claim 7, wherein the EC motor is controlled by regulating direct (d) and quadrature (q) components of a voltage from a Park transformation of voltages of the phases, and wherein the voltage signal is injected exclusively into the d component.

9. The method according to claim 6, further comprising determining a condition for suspending the injection based upon the determined position of the rotor.

10. The method according to claim 6, wherein the d component and the q component are determined using separate proportional-integral controllers.

11. The method according to claim 6, further comprising controlling the EC motor based upon the determined rotor position.
